(19) United States
(12) Patent Application Publication
(10) Pub. No.: US 2018/0368216 A1
(43) Pub. Date: Dec. 20, 2018

(54) APPARATUS FOR HEATING AND METHOD

(71) Applicant: Dale Bouck, Whitehall, MI (US)

(72) Inventor: Dale Bouck, Whitehall, MI (US)

(21) Appl. No.: 16/005,565

(22) Filed: Jun. 11, 2018

Related U.S. Application Data
(60) Provisional application No. 62/519,828, filed on Jun. 14, 2017.

(51) Int. Cl. H05B 6/80

(52) U.S. Cl. CPC H05B 6/804

(57) ABSTRACT

An apparatus for heating includes an elongate body having an upper end and a lower end, a first end cap removably attached to the upper end of the elongate body, and a second end cap removably attached to the lower end of the elongate body. The elongate body comprises a first section having a fan and a second section. Additionally, the first end cap includes a plurality of apertures being spaced apart in a substantially equidistant configuration. The apparatus is useful for providing a source of heating for homes, buildings, or other structures.

### CROSS-REFERENCE TO RELATED APPLICATION(S)

The present application is related to and claims priority to U.S. Provisional Patent Application No. 62/519,828 filed Jun. 14, 2017, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of heating systems of existing art and more specifically relates to fluid-based heating systems.

### RELATED ART

Traditional methods of heating a structure or vehicle produce carbon dioxide emissions, which cause accidental fatalities. These heating systems also contribute to global warming. The prices of gas, coal, propane, and wood can be unstable and can lead to high energy costs. Microwave energy has in the past been used to provide heat. The most widely known usage of microwave energy is the microwave oven. Microwave energy is clean and efficient. With microwave heat, no heat is lost in flue gases as none exist.

A suitable alternative is needed wherein an efficient heater utilizing microwave energy for use in both commercial buildings and in residential structures would result in reduced fuel consumption by use of a clean heating system that is comparatively economical.

U.S. Pat. No. 8,242,421 to Alfred Monteleone, et al. relates to a dual heating system using microwave energy. The described dual heating system using microwave energy includes a heating system that comprises both heating a fluid heating media and heating domestic hot water. The system includes an enclosure, a heating tank, a magnetron chamber, at least one heating rod with a hollow interior. At least one heat absorbing mixture or media is located within the hollow interior of each heating rod, and a microwave guide is associated with each heating rod to direct heat energy to the heat absorbing media. A magnetron is associated with each microwave wave guide. At least one inlet and at least one outlet for conveying the fluid heating media into and out of the heating tank. At least one inlet and at least one outlet for conveying the domestic hot water into and out of the heating tank.

### SUMMARY OF THE INVENTION

In view of the foregoing disadvantages inherent in the known heating systems art, the present disclosure provides a novel apparatus for heating and method. The general purpose of the present disclosure, which will be described subsequently in greater detail, is to provide a fluid-based system for heating homes, buildings, RVs, trailers, and more.

An apparatus for heating is disclosed herein. The apparatus for heating may include an elongate body having an upper end and a lower end, a first end cap removably attached to the upper end of the elongate body, and a second end cap removably attached to the lower end of the elongate body. The elongate body may be comprised of a first section having a fan and a second section. Additionally, the first end cap may include a plurality of apertures being spaced apart in a substantially equidistant configuration. The apparatus may be useful for providing a source of heating for homes, buildings, or other structures.

According to another embodiment, a method of using an apparatus for heating is also disclosed herein. The method of using an apparatus for heating may include providing an apparatus for heating having an elongate body, a first end cap, a second end cap, and a fan, and circulating a fluid through a pressure relief valve.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, an apparatus for heating and method, constructed and operative according to the teachings of the present disclosure.

FIG. 1 is a perspective view of the apparatus for heating during an ‘in-use’ condition, according to an embodiment of the disclosure.

FIG. 2 is an exposed side view of the apparatus for heating of FIG. 1, according to an embodiment of the present disclosure.

FIG. 3 is a side cut-away view of the apparatus for heating of FIG. 1, according to an embodiment of the present disclosure.

FIG. 4 is a side perspective view of the apparatus for heating of FIG. 1, according to an embodiment of the present disclosure.

FIG. 5 is a flow diagram illustrating a method of using an apparatus for heating, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a heating system and more particularly to an apparatus for heating and method as used to provide a fluid-based system for heating homes, buildings, RVs, trailers, and more.

Generally, the apparatus for heating of this disclosure may include a central sealed chamber, magnetron, fan or blower assembly, pressure relief mechanisms, thermostat control, and heat exchanger assembly. The assembly may use a fluid that is circulated through a system pressure relief valve, circulating pump, through heating tubing, aquastat, and heating chamber. The fluid then may go through microwave blocking system into a heating chamber which is heated by a magnetron system and than through a heat exchange system.

In a preferred embodiment, the apparatus may also include a cooling mechanism that may incorporate cool water from a continuous supply such as an indoor water faucet, outdoor tap nozzle, or other open supply. The cooling mechanism may include a valve that allows fluid to be selectively cooled while not closed for heat. The cooling mechanism may further provide a dump release that enables heated water to be expelled from or recycled through the apparatus. In addition, the cooling mechanism may feature a pump for circulating the fluid through the apparatus or other related systems.

The units can be stacked upon each other or combined, which creates a zone. This zone can then be controlled by an individual thermostat. The system can then heat larger areas by forming multiple units. The system can also be used within RV's, travel trailers, fifth wheels, pools, hot tubs, etc. The exact specifications may vary. Upon reading this specification, it should be appreciated that, under appropriate circumstances, considering such issues as user preferences, design preference, structural requirements, marketing preferences, cost, available materials, technological advances, etc., other heating system arrangements such as, for example, stackable units of different shapes, etc., may be sufficient.

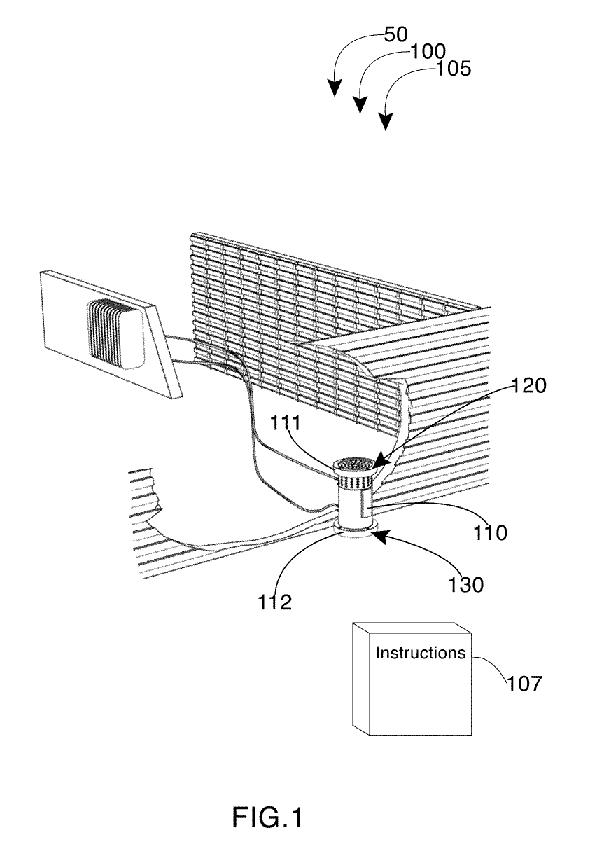

Referring now more specifically to the drawings by numerals of reference, there is shown in FIGS. 1-4, various views of an apparatus for heating 100.

FIG. 1 shows an apparatus for heating 100 during an ‘in-use’ condition 50, according to an embodiment of the present disclosure. Here, the apparatus for heating 100 may be beneficial for use by a user to provide a fluid-based system for heating homes, buildings, RVs, trailers, and more. As illustrated, the apparatus for heating 100 may include an elongate body 110 having an upper end 111 and a lower end 112. The apparatus 100 may also include a first end cap 120 removably attached to the upper end 111 of the elongate body 110 and a second end cap 130 removably attached to the lower end 112 of the elongate body 110.

According to one embodiment, the apparatus for heating 100 may be arranged as a kit 105. In particular, the apparatus for heating 100 may further include a set of instructions 107. The instructions 107 may detail functional relationships in relation to the structure of the apparatus for heating 100 such that the apparatus for heating 100 can be used, maintained, or the like, in a preferred manner.

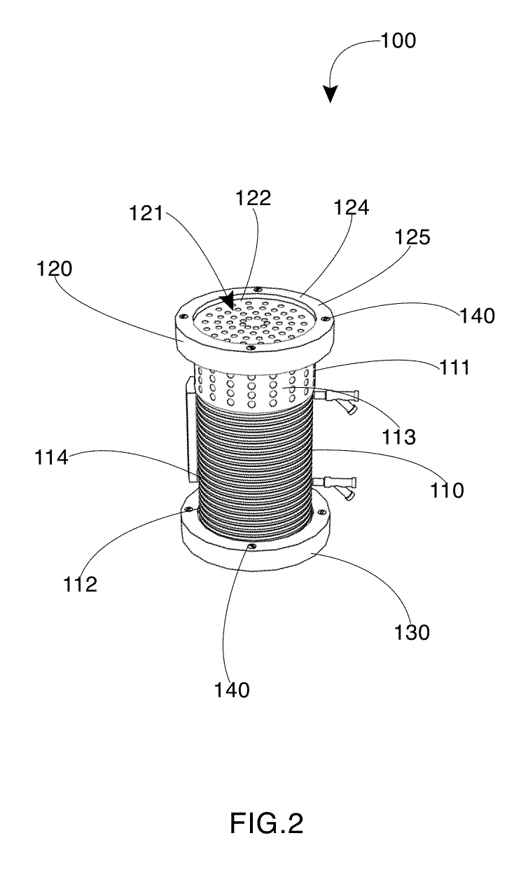

FIG. 2 shows the apparatus for heating 100 of FIG. 1, according to an embodiment of the present disclosure. As above, the apparatus for heating 100 may include an elongate body 110 having an upper end 111 and a lower end 112. The apparatus 100 may also include a first end cap 120 removably attached to the upper end 111 of the elongate body 110 and a second end cap 130 removably attached to the lower end 112 of the elongate body 110. The first end cap 120 may include a plurality of apertures 121 in substantially equidistant configuration upon the upper surface 122 of the first end cap 120. The elongate body 110 may further be comprised of a first section 113 and a second section 114. The upper surface 122 of the first end cap 120 may include a raised portion 124 located along an outer periphery 125 of the first end cap 120. Finally, both the first end cap 120 and the second end cap 130 may be affixed to their respective ends of the elongate body 110 by a plurality of screws 140.

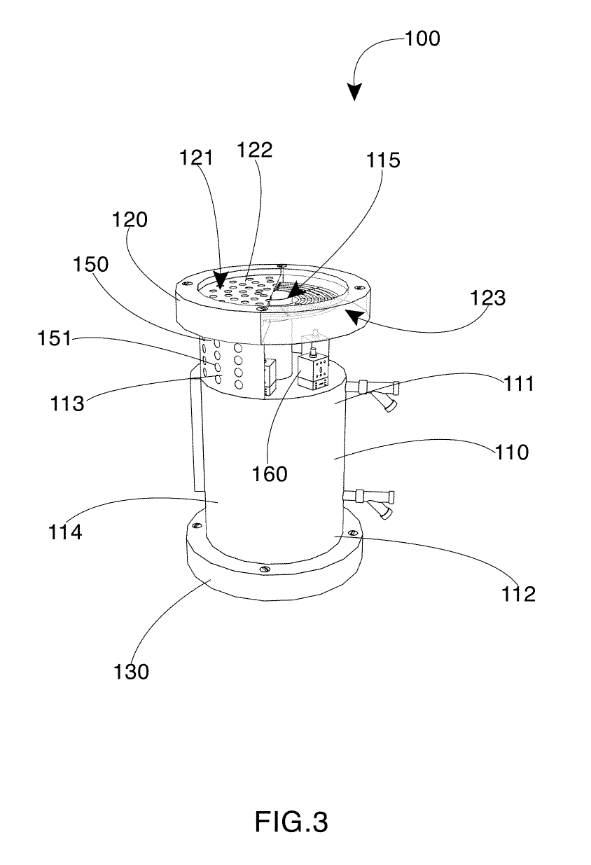

Referring now to FIG. 3, a side cut-away view of the apparatus for heating 100 of FIG. 1, according to an embodiment of the present disclosure. Here again, the apparatus for heating 100 may include an elongate body 110 having an upper end 111 and a lower end 112. The apparatus 100 may also include a first end cap 120 removably attached to the upper end 111 of the elongate body 110 and a second end cap 130 removably attached to the lower end 112 of the elongate body 110. The first end cap 120 may include a bottom surface 123 and a plurality of apertures 121 in substantially equidistant configuration upon the upper surface 122 of the first end cap 120. The elongate body 110 may further be comprised of a first section 113 and a second section 114. The first section 113 may include a fan 115 configured to provide cooling to the apparatus 100 along with a plurality of holes 150 in an array configuration 151 that allow air to flow through the apparatus 100. Finally, the first section 113 may also comprise a control box 160 for regulating fluids and internal temperatures.

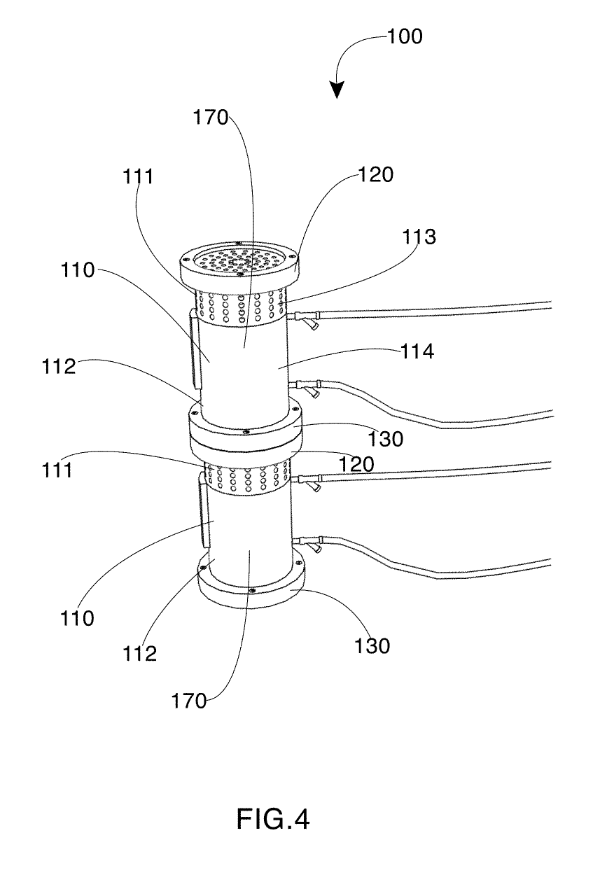

FIG. 4 is a side perspective view of the apparatus for heating 100 of FIG. 1, according to an embodiment of the present disclosure. As above, the apparatus for heating 100 may include an elongate body 110 having an upper end 111 and a lower end 112. The apparatus 100 may also include a first end cap 120 removably attached to the upper end 111 of the elongate body 110 and a second end cap 130 removably attached to the lower end 112 of the elongate body 110. The elongate body 110 may further be comprised of a first section 113 and a second section 114. Finally, the apparatus 100 may be configured to combine with another such apparatus 100 as a stackable unit 170 that allows for the creation of zones.

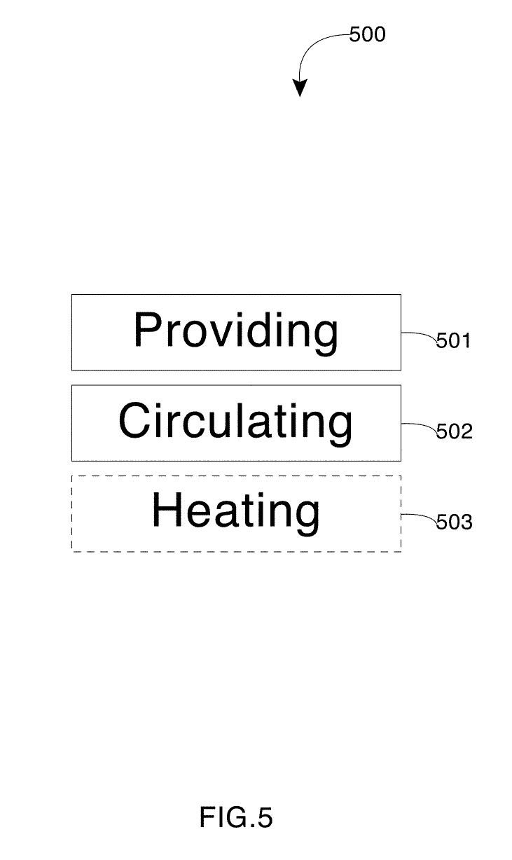

FIG. 5 is a flow diagram illustrating a method of using 500 an apparatus for heating 100, according to an embodiment of the present disclosure. In particular, the method of using 500 an apparatus for heating 100 may include one or more components or features of the apparatus for heating 100 as described above. As illustrated, the method of using 500 an apparatus for heating 100 may include the steps of: step one 501, providing an elongate body having an upper end, a lower end, a first end cap removably attached to the upper end of the elongate body, a second end cap removably attached to the lower end of the elongate body, a plurality of apertures being spaced apart from one another in substantially equidistant configuration, a first section, a second section, and a fan; and, step two 502, circulating a fluid through a pressure relief valve.

It should be noted that step 503, heating the fluid by using a magnetron system, is an optional step and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for the apparatus for heating, are taught herein such as the apparatus including a central sealed chamber, magnetron, fan and alternately a blower assembly, pressure relief mechanisms, thermostat control, and heat exchanger assembly; and wherein the apparatus is able to use a fluid that is circulated through a system pressure relief valve, circulating pump, through heating tubing, aquastat, and at least one heating chamber; the fluid passing through a microwave blocking system into a heating chamber which is heated by a magnetron system and then through said heat exchanger assembly.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An apparatus for heating, comprising:
an elongate body having an upper end and a lower end;
a first end cap, the first end cap removably attached to the upper end of the elongate body;
a second end cap, the second end cap removably attached to the lower end of the elongate body;
wherein the first end cap has a plurality of apertures, the plurality of apertures being spaced apart from one another in substantially equidistant configuration;
wherein the elongate body is comprised of a first section and a second section; and
wherein the first section includes a fan configured to provide cooling.

2. The apparatus of claim 1, wherein the elongate body is cylindrical in shape.

3. The apparatus of claim 1, wherein the first end cap is removably attached to the upper end by a plurality of screws.

4. The apparatus of claim 3, wherein the plurality of screws comprises exactly 4 screws.

5. The apparatus of claim 1, wherein the second end cap is removably attached to the lower end by a plurality of screws.

6. The apparatus of claim 5, wherein the plurality of screws comprises 4 screws.

7. The apparatus of claim 1, wherein the first end cap and the second end cap are circular in shape.

8. The apparatus of claim 1, wherein the first end cap has an upper surface and a bottom surface.

9. The apparatus of claim 8, wherein the upper surface of the first end cap has a raised portion.

10. The apparatus of claim 9, wherein the raised portion is located along an outer periphery of the first end cap.

11. The apparatus of claim 1, wherein the first section is located near the first end cap.

12. The apparatus of claim 1, wherein the second section is located near the second end cap.

13. The apparatus of claim 11, wherein the first section comprises a plurality of holes.

14. The apparatus of claim 13, wherein the plurality of holes has an array configuration.

15. The apparatus of claim 1, wherein the first section is a control box.

16. The apparatus of claim 1, wherein the apparatus is configured to be a stackable unit.

17. An apparatus for heating, comprising:
an elongate body having an upper end and a lower end;
a first end cap, the first end cap removably attached to the upper end of the elongate body;
a second end cap, the second end cap removably attached to the lower end of the elongate body;
wherein the first end cap has a plurality of apertures, the plurality of apertures being spaced apart from one another in substantially equidistant configuration;
wherein the elongate body is comprised of a first section and a second section;
wherein the first section includes a fan configured to provide cooling;
wherein the elongate body is cylindrical in shape;
wherein the first end cap is removably attached to the upper end by a plurality of screws as fasteners;
wherein the plurality of screws comprises exactly 4 screws;
wherein the second end cap is removably attached to the lower end by a plurality of screws;
wherein the plurality of screws comprises 4 said screws;
wherein the first end cap and the second end cap are circular in shape;
wherein the first end cap has an upper surface and a bottom surface;
wherein the upper surface of the first end cap has a raised portion;
wherein the raised portion is located along an outer periphery of the first end cap;
wherein the first section is located near the first end cap;
wherein the second section is located near the second end cap;
wherein the first section comprises a plurality of holes;
wherein the plurality of holes has an array configuration;
wherein the first section is a control box;
wherein the apparatus is configured to be a stackable unit;
wherein the apparatus includes a central sealed chamber, magnetron, fan and alternately a blower assembly, pressure relief mechanisms, thermostat control, and heat exchanger assembly; and
wherein the apparatus is able to use a fluid that is circulated through a system pressure relief valve, circulating pump, through heating tubing, aquastat, and at least one heating chamber, the fluid passing through a microwave blocking system into a heating chamber which is heated by a magnetron system and then through said heat exchanger assembly.

18. The apparatus of claim 17, further comprising set of instructions; and wherein the apparatus for heating is arranged as a kit.

19. A method of using an apparatus for heating, the method comprising the steps of:
providing an elongate body having an upper end and a lower end;
a first end cap, the first end cap removably attached to the upper end of the elongate body;
a second end cap, the second end cap removably attached to the lower end of the elongate body;
a plurality of apertures, the plurality of apertures being spaced apart from one another in substantially equidistant configuration;
a first section and a second section; and
a fan; and
circulating a fluid through a pressure relief valve.

20. The method of claim 19, further comprising the step of:
heating the fluid by using a magnetron system.
